(19) United States
(12) Patent Application Publication
(10) Pub. No.: US 2012/0141696 A1
(43) Pub. Date: Jun. 7, 2012

(54) ELASTOMER COMPOSITION MADE FROM A THERMOPLASTIC COPOLYMER, INFLATABLE OBJECT PROVIDED WITH A GAS BARRIER MADE FROM SUCH A COMPOSITION

(75) Inventors: Vincent Abad, Chamalieres (FR); Marc Greiveldinger, Chatel Guyon (FR); Julien Thuilliez, La Rouche-Blanche (FR)

(73) Assignee: SOCIETE DE TECHNOLOGIE MICHELIN, Clermont-Ferrand (FR)

(21) Appl. No.: 13/375,716

(22) PCT Filed: Jun. 1, 2010
(86) PCT No.: PCT/EP10/57659

§ 371 Date: Feb. 13, 2012

(30) Foreign Application Priority Data
Jun. 2, 2009 (FR) 0902651

(51) Int. Cl. B32B 25/18; B60C 19/00; B05D 7/22; B60C 5/02; C08F 293/00; C08L 23/22

(52) U.S. Cl. 428/12; 525/55; 525/314; 525/299; 525/294; 524/579; 427/230; 152/510; 152/511

(57) ABSTRACT

Elastomer composition comprising at least, as predominant elastomer, a thermoplastic SIBS elastomer comprising a “polyisobutylene” block and, at least one of the ends of the “polyisobutylene” block, a thermoplastic block of specific structure having a Tg greater than or equal to 100° C. The elastomer composition according to the invention may be used as an elastomer layer impermeable to the inflation gases in an inflatable object. This inflatable object is, in particular, an inner tube or a pneumatic tyre for a motor vehicle.

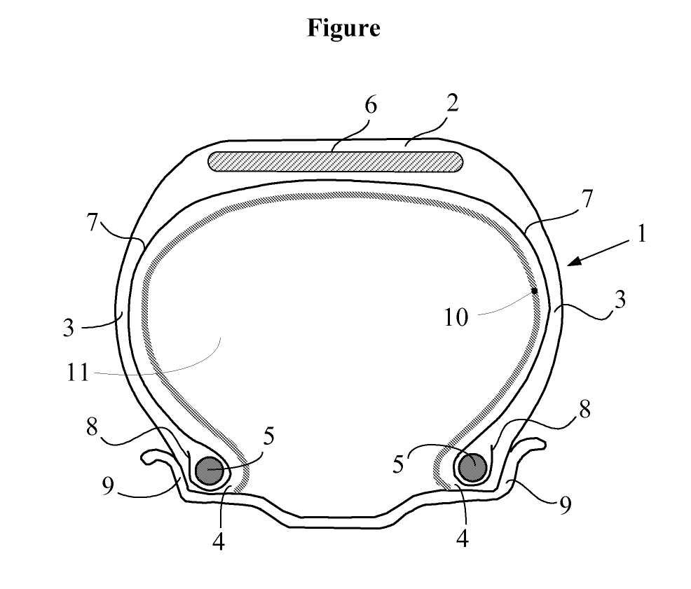

The present invention relates to an elastomeric composition comprising a thermoplastic elastomer of block copolymer type comprising an elastomeric block composed of a “polyisobutylene” and one or more thermoplastic blocks.

More particularly, the invention relates to compositions of this type that may be used as gastight layers for sealing inflatable objects, i.e., by definition, objects that take their working shape when they are inflated with air or an equivalent inflation gas. In particular, these inflatable objects are pneumatic tyres.

In a conventional pneumatic tyre of the “tubeless” type (i.e. without an inner tube), the radially inner face comprises a layer that is airtight (or more generally impermeable with respect to any inflation gas) for inflating the pneumatic tyre and keeping it under pressure. Its sealing properties ensure relatively low pressure loss, making it possible to keep the tyre inflated in the state of normal functioning for a sufficient duration, normally for several weeks or several months. It also has a function of protecting the carcass reinforcement against the diffusion of air originating from the inner space of the tyre.

This function as an airtight inner layer or inner liner is currently fulfilled by compositions based on butyl rubber (copolymer of isobutylene and isoprene), which have been known for a very long time for their excellent sealing properties.

However, a well-known drawback of compositions based on butyl elastomer or rubber is that they have large hysteretic losses, and what is more, over a broad temperature spectrum, this drawback penalizes the rolling resistance of pneumatic tyres.

Reducing the hysteresis of these inner sealing layers and thus, ultimately, the fuel consumption of motor vehicles, is a general objective with which the current technology is confronted.

In the prior patent applications FR 08/57844 and FR 08/57845, the Applicants describe a novel thermoplastic elastomer of SIBS type. This novel SIBS, when used in a composition optionally extended with an extender oil, induces surprising and unexpected dynamic properties in said composition, which make this composition particularly suitable for manufacturing inner sealing layers, especially for motor vehicle tyres. Advantageously, this SIBS allows the production of inner sealing layers that have improved hysteresis properties while at the same time affording these said inner layers very good sealing properties and a capacity for adhesion to the rubber components adjacent thereto.

Besides the improved hysteresis properties, the improvement of the heat resistance of compositions for inner sealing layers is a continuous axis of research especially with a view to ensuring good cohesion of the composition when hot, even under extreme working conditions, for instance running at very high speed or in an environment whose ambient temperature is high, or alternatively during the annealing of tyres during which the temperatures may reach more than 200° C.

The heat resistance of a block thermoplastic elastomer is a function of the value of the glass transition temperature and/or of the melting point of the thermoplastic blocks. For certain applications, the value of the glass transition temperature of the side blocks of certain SIBSs is insufficient and does not make it possible to envision the use of these SIBSs for producing inner sealing layers subjected especially to extreme working conditions.

The aim of the present invention is thus to improve the thermal behaviour of thermoplastic elastomer-based compositions, while at the same time maintaining good sealing properties, and also hysteresis properties that are satisfactory for use in tyres.

In the continuance of their research, the Inventors have discovered that the use of certain block thermoplastic elastomers in elastomeric compositions gives these compositions good hot cohesion, especially at temperatures above 100° C., or even above 150° C. In addition, these specific thermoplastic elastomers give the compositions containing them good sealing properties and also hysteresis properties that are satisfactory for use in tyres and especially as an inner layer of tyres.

Thus, according to a first subject, the present invention relates to an elastomeric composition comprising at least, as majority elastomer, one block thermoplastic elastomer of specific structure.

Another subject of the invention is an inflatable object equipped with an elastomeric layer that is impermeable to inflation gases such as air, said elastomeric layer being formed from the elastomeric composition comprising at least, as majority elastomer, one block thermoplastic elastomer of specific structure.

Compared with butyl rubbers, and just like SIBSs, this thermoplastic elastomer of specific structure also has the major advantage, on account of its thermoplastic nature, of being able to be worked in melt form (liquid), and consequently of offering the possibility of simplified implementation.

The invention particularly relates to rubber inflatable objects such as pneumatic tyres, or inner tubes, especially pneumatic tyre inner tubes.

The invention more particularly relates to pneumatic tyres intended for equipping motor vehicles of the passenger type, SUVs (Sport Utility Vehicles), two-wheeled vehicles (especially motorcycles), and aircraft, and industrial vehicles chosen from vans, heavy vehicles—i.e. underground trains, buses, heavy road transport vehicles (lorries, towing vehicles, trailers), offroad vehicles such as agricultural or civil engineering vehicles—, other transport or handling vehicles.

The invention also relates to a process for sealing an inflatable object with respect to the inflation gases, in which a gastight elastomeric layer as mentioned above is incorporated into said inflatable object during its manufacture, or is added to said inflatable object after its manufacture.

The invention also relates to the use as a layer that is impermeable to inflation gases, in an inflatable object, of an elastomeric layer as mentioned above.

In the present description, unless expressly mentioned otherwise, all the percentages (%) are indicated as mass percentages.

In the description of the invention that follows, the terms “block thermoplastic elastomer”, “block thermoplastic elastomeric copolymer” and “block copolymer” are equivalent and may be used indiscriminately.

Moreover, any range of values denoted by the term (“between a and b” represents the range of values going from more than a to less than b (i.e. limits a and b excluded), whereas any range of values denoted by the term “from a to b” means the range of values going from a up to b (i.e. including the strict limits a and b).

Thus, a first subject of the invention is an elastomeric composition comprising at least, as majority (by weight) elastomer, one block thermoplastic elastomer of specific structure.

This block thermoplastic elastomer of specific structure is a block copolymer comprising at least one “polyisobutylene” elastomeric block composed predominantly of polymerized isobutene monomer and, at least one of the ends of the elastomeric block, a thermoplastic block formed from at least one polymerized monomer, other than a styrene or indene monomer, the glass transition temperature (Tg, measured according to ASTM D3418) of said polymer constituting the thermoplastic block is greater than or equal to 100° C. This block thermoplastic elastomeric copolymer has the following structural characteristics:
1) the “polyisobutylene” block has a number-average molecular mass (“Mn”) ranging from 25 000 g/mol to 350 000 g/mol and a glass transition temperature (“Tg”) of less than or equal to −20° C.,
2) the thermoplastic block(s) with an upper glass transition temperature (“Tg”) of greater than or equal to 100° C. and formed from at least one polymerized monomer, other than a styrene or indene monomer.

According to a first variant of the invention, the block thermoplastic elastomeric copolymer is in a linear diblock form. The block copolymer is then composed of a “polyisobutylene” block and a thermoplastic block.

According to a particularly preferred variant of the invention, the thermoplastic elastomeric block copolymer is in a linear triblock form. The block copolymer is then composed of a central “polyisobutylene” block and two terminal thermoplastic blocks, at each of the two ends of the “polyisobutylene” block.

According to another variant of the invention, the thermoplastic elastomeric block copolymer is in a star form with at least three arms. The block copolymer is then a star “polyisobutylene” block with at least three arms and a thermoplastic block, located at the end of each of the arms of the “polyisobutylene”. The number of “polyisobutylene” arms ranges from 3 to 12 and preferably from 3 to 6.

According to another variant of the invention, the thermoplastic elastomeric block copolymer is in a branched or dendrimer form. The block copolymer is then composed of a branched or dendrimer “polyisobutylene” block and of a thermoplastic block, located at the end of the arms of the dendrimer “polyisobutylene”.

The number-average molecular mass (noted Mn) of the block copolymer is preferentially between 30 000 and 500 000 g/mol and more preferentially between 40 000 and 400 000 g/mol. Below the indicated minima, the cohesion between the elastomeric chains of the TPE, especially on account of its possible dilution (in the presence of an extender oil), risks being affected; moreover, an increase in the working temperature risks affecting the mechanical properties, especially the properties at failure, with as a consequence reduced “hot” performance. Moreover, an excessively high mass Mn may be penalizing on the flexibility of the gastight layer. Thus, it has been found that a value within a range from 50 000 to 300 000 g/mol was particularly suitable, especially for a use of the block copolymer in a pneumatic tyre composition.

The value of the polydispersity index Ip (reminder: Ip=Mw/Mn with Mw being the weight-average molecular mass) of the block copolymer is preferably less than 3; more preferentially less than 2 and even more preferentially less than 1.5.

According to the invention, the “polyisobutylene” block of the block copolymer is predominantly composed of isobutene-based units. The term “predominantly” means the highest weight content of monomer relative to the total weight of the “polyisobutylene” block, and preferably a weight content of more than 50%, more preferentially more than 75% and even more preferentially more than 85%.

According to the invention, the “polyisobutylene” block of the block copolymer has a number-average molecular mass (“Mn”) ranging from 25 000 g/mol to 350 000 g/mol and preferably from 35 000 g/mol to 250 000 g/mol so as to give the TPE good elastomeric properties and mechanical strength that is sufficient and compatible with the application as pneumatic tyre inner rubber.

According to the invention, the “polyisobutylene” block of the block copolymer also has a glass transition temperature (“Tg”) of less than or equal to −20° C. and more preferentially less than −40° C. A Tg value above these minima may reduce the performance of the airtight layer during use at very low temperature; for such a use, the Tg of the block copolymer is even more preferentially less than −50° C.

Advantageously, according to the invention, the “polyisobutylene” block of the block copolymer may also comprise a content of one or more conjugated dienes inserted into the polymer chain. The content of diene-based units is defined by the sealing properties that the block copolymer must have. Preferentially, the content of diene-based units ranges from 0.5% to 16% by weight relative to the weight of the “polyisobutylene” block, more preferentially from 1% to 10% by weight and even more preferentially from 2% to 8% by weight relative to the weight of the “polyisobutylene” block.

The conjugated dienes that may be copolymerized with isobutylene to form the “polyisobutylene” block are C₄-C₁₄ conjugated dienes. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene and 1-vinyl-1,3-cyclohexadiene or a mixture thereof. More preferentially, the conjugated diene is isoprene or a mixture containing isoprene.

According to one advantageous aspect of the invention, the “polyisobutylene” block may be halogenated and comprise halogen atoms in its chain. This halogenation makes it possible to increase the rate of crosslinking of the composition comprising the block copolymer according to the invention. The halogenation is performed using bromine or chlorine, preferentially bromine, on conjugated diene-based units of the polymer chain of the “polyisobutylene” block. Only some of these units react with the halogen. This portion of units derived from reactive conjugated dienes must nevertheless be such that the content of units derived from conjugated dienes that have not reacted with the halogen is at least 0.5% by weight relative to the weight of the “polyisobutylene” block.

According to the invention, the thermoplastic block(s) have a Tg of greater than or equal to 100° C. According to one preferential aspect of the invention, the Tg of the thermoplastic block is greater than or equal to 130° C., even more preferentially greater than or equal to 150° C., or even greater than or equal to 200° C.

The proportion of thermoplastic block(s) relative to the block copolymer is determined, on the one hand, by the thermoplasticity properties that said copolymer must have. The thermoplastic blocks with a Tg of greater than or equal to 100° C. must be present in sufficient proportions to preserve the thermoplastic nature of the elastomer according to the invention. The minimum content of thermoplastic blocks with a Tg of greater than or equal to 100° C. in the block copolymer may vary as a function of the working conditions of the copolymer. Moreover, the capacity of the block copolymer to become deformed during the conformation of the tyre may also contribute towards determining the proportion of thermoplastic blocks with a Tg of greater than or equal to 100° C.

In the present description, the term “thermoplastic block with a Tg of greater than or equal to 100° C.” should be understood as meaning any polymer based on at least one polymerized monomer other than a styrene or indene monomer, whose glass transition temperature is greater than 100° C. and whose block copolymer according to the invention containing it can be synthesized by a person skilled in the art and has the characteristics defined above.

In the present description, the term “styrene monomer” should be understood as meaning any unsubstituted or substituted styrene-based monomer; among the substituted styrenes that may be mentioned, for example, are methylstyrenes (for example o-methylstyrene, m-methylstyrene or p-methylstyrene, α-methylstyrene, α-2-dimethylstyrene, α-4-dimethylstyrene or diphenylethylene), para-tert-butylstyrene, chlorostyrenes (for example o-chlorostyrene, m-chlorostyrene, p-chlorostyrene, 2,4-dichlorostyrene, 2,6-dichlorostyrene or 2,4,6-trichlorostyrene), bromostyrenes (for example o-bromostyrene, m-bromostyrene, p-bromostyrene, 2,4-dibromostyrene, 2,6-dibromostyrene or 2,4,6-tribromo-styrene), fluorostyrenes (for example o-fluorostyrene, m-fluorostyrene, p-fluorostyrene, 2,4-difluorostyrene, 2,6-difluorostyrene or 2,4,6-trifluorostyrene) or para-hydroxystyrene.

In the present description, the term “indene monomer” should be understood as meaning any substituted or unsubstituted indene-based monomer; among the substituted indene monomers that may be mentioned, for example, are alkylindenes and arylindenes.

In the present description, the term “polymerized monomer other than a styrene or indene monomer” should be understood as meaning any monomer, other than a styrene or indene monomer, polymerized by a person skilled in the art according to known techniques and that may lead to the preparation of block copolymers comprising a “polyisobutylene” block according to the invention.

As illustrative but nonlimiting examples, the polymerized monomers other than styrene or indene monomers according to the invention that may be used for the preparation of thermoplastic blocks with a Tg of greater than or equal to 100° C. may be chosen from the following compounds, and mixtures thereof:
acenaphthylene. A person skilled in the art may refer, for example, to the article by Z. Fodor and J. P. Kennedy, Polymer Bulletin 1992 29(6) 697-705;
isoprene, then leading to the formation of a certain number of poly(trans-1,4-isoprene) units and of cyclized units according to an intramolecular process. A person skilled in the art may refer, for example, to the documents G. Kaszas, J. E. Puskas, P. Kennedy Applied Polymer Science (1990) 39(1) 119-144 and J. E. Puskas, G. Kaszas, J. P. Kennedy, Macromolecular Science, Chemistry A28 (1991) 65-80;
acrylic acid esters, acrylic acid, crotonic acid, sorbic acid and methacrylic acid esters, acrylamide derivatives, methacrylamide derivatives, acrylonitrile derivatives, methacrylonitrile derivatives, and mixtures thereof. Mention may be made more particularly of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyl-adamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-tert-butylcyclohexyl methacrylate, tert-butyl methacrylate, 4-tert-butylphenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-sec-butylacrylamide, N-tert-butylacrylamide, N,N-diisopropylacrylamide, N-1-methylbutylacrylamide, N-methyl-N-phenylacrylamide, morpholylacrylamide, piperidylacrylamide, N-tert-butylmethacrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenyl acrylate, acrylonitrile and methacrylonitrile, and mixtures thereof.

According to one variant of the invention, the polymerized monomer other than a styrene or indene monomer may be copolymerized with at least one other monomer so as to form a thermoplastic block with a Tg of greater than or equal to 100° C. According to this aspect, the mole fraction of polymerized monomer other than a styrene or indene monomer, relative to the total number of units of the thermoplastic block, must be sufficient to reach a Tg of greater than or equal to 100° C., preferentially greater than or equal to 130° C., even more preferentially greater than or equal to 150° C., or even greater than or equal to 200° C. Advantageously, the mole fraction of this other comonomer may range from 0 to 90%, more preferentially from 0 to 75% and even more preferentially from 0 to 50%.

By way of illustration, this other monomer capable of copolymerizing with the polymerized monomer other than a styrene or indene monomer may be chosen from diene monomers, more particularly conjugated diene monomers containing 4 to 14 carbon atoms, monomers of vinylaromatic type containing from 8 to 20 carbon atoms, and indene monomers.

When the comonomer is a conjugated diene containing 4 to 12 carbon atoms, it advantageously represents a mole fraction relative to the total number of units of the thermoplastic block ranging from 0 to 25%. As conjugated dienes that may be used in the thermoplastic blocks according to the invention, those described above are suitable, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene and 1-vinyl-1,3-cyclohexadiene, or a mixture thereof.

When the comonomer is of vinylaromatic type, it advantageously represents a fraction of units relative to the total number of units of the thermoplastic block of from 0 to 90%, preferentially ranging from 0 to 75% and even more preferentially ranging from 0 to 50%. Vinylaromatic compounds that are especially suitable for use include the styrene monomers mentioned above, namely methylstyrenes, para-tert-butylstyrene, chlorostyrenes, bromostyrenes, fluorostyrenes or para-hydroxystyrene. Preferably, the comonomer of vinylaromatic type is styrene.

As illustrative but nonlimiting examples, mention may be made of mixtures of comonomers that may be used for the preparation of thermoplastic blocks with a Tg of greater than or equal to 100° C., formed from indene and styrene derivatives, especially para-methylstyrene or para-tert-butylstyrene. A person skilled in the art may refer to documents J. E. Puskas, G. Kaszas, J. P. Kennedy, W. G. Hager, Journal of Polymer Science part A: Polymer Chemistry 1992 30, 41 or J. P. Kennedy, S. Midha, Y. Tsungae, Macromolecules (1993) 26, 429.

When the comonomer is of indene type, it advantageously represents a fraction of units relative to the total number of units of the thermoplastic block of from 0 to 90%, preferentially ranging from 0 to 75% and even more preferentially ranging from 0 to 50%. Indene monomers that may be mentioned include indene and derivatives thereof, for instance 2-methylindene, 3-methylindene, 4-methylindene, dimethylindenes, 2-phenylindene, 3-phenylindene and 4-phenylindene. A person skilled in the art may refer, for example, to U.S. Pat. No. 4,946,899 by the Inventors Kennedy, Puskas, Kaszas and Hager and to documents J. E. Puskas, G. Kaszas, J. P. Kennedy, W. G. Hager Journal of Polymer Science Part A: Polymer Chemistry (1992) 30, 41 and J. P. Kennedy, N. Meguriya, B. Keszler, Macromolecules (1991) 24(25), 6572-6577.

The block thermoplastic elastomeric copolymers of the invention may be prepared via synthetic processes that are known per se and described in the literature, especially that mentioned in the presentation of the prior art of the present description. A person skilled in the art will know how to select the appropriate polymerization conditions and to regulate the various polymerization process parameters so as to achieve the specific structure characteristics for the block copolymer of the invention.

Several synthetic strategies may be used in order to prepare the copolymers according to the invention.

A first consists of a first step of synthesis of the “polyisobutylene” block by living cationic polymerization of the monomers to be polymerized by means of a monofunctional, difunctional or polyfunctional initiator known to those skilled in the art, followed by a second step of synthesis of the thermoplastic block(s) with a Tg of greater than or equal to 100° C. and by adding the monomer to be polymerized to the living polyisobutylene obtained in the first step. Thus, these two steps are consecutive, which is reflected by the sequential addition:
of the monomers to be polymerized for the preparation of the “polyisobutylene” block;
of the monomers to be polymerized for the preparation of the thermoplastic block(s) with a Tg of greater than or equal to 100° C.

At each step, the monomer(s) to be polymerized may or may not be added in the form of a solution in a solvent as described below, in the presence or absence of a Lewis acid or base as described below.

Each of these steps may be performed in the same reactor or in two different polymerization reactors. Preferentially, these two steps are performed in one and the same reactor (“one-pot” synthesis).

Living cationic polymerization is conventionally performed by means of a difunctional or polyfunctional initiator and optionally a Lewis acid acting as coinitiator in order to form in-situ a carbocation. Usually, electron-donating compounds are added in order to give the polymerization a living nature.

By way of illustration, the difunctional or polyfunctional initiators that may be used for the preparation of the copolymers according to the invention may be chosen from 1,4-bis(2-methoxy-2-propyl)benzene (or dicumyl methyl ether), 1,3,5-tris(2-methoxy-2-propyl)benzene (or tricumyl methyl ether), 1,4-bis(2-chloro-2-propyl)benzene (or dicumyl chloride), 1,3,5-tris(2-chloro-2-propyl)benzene (or tricumyl chloride), 1,4-bis(2-hydroxy-2-propyl)benzene, 1,3,5-tris(2-hydroxy-2-propyl)benzene, 1,4-bis(2-acetoxy-2-propyl)benzene, 1,3,5-tris(2-acetoxy-2-propyl)benzene, 2,6-dichloro-2,4,4,6-tetramethylheptane and 2,6-dihydroxy-2,4,4,6-heptane. Dicumyl ethers, tricumyl ethers, dicumyl halides or tricumyl halides are preferentially used.

The Lewis acids may be chosen from metal halides of general formula MXn where M is an element chosen from Ti, Zr, Al, Sn, P, B, X is a halogen such as Cl, Br, F or I and n corresponds to the degree of oxidation of the element M. Mention will be made, for example, of TiCl₄, AlCl₃, BCl₃, BF₃, SnCl₄, PCl₃ and PCl₅. Among these compounds, TiCl₄, AlCl₃ and BCl₃ are preferentially used, and TiCl₄ even more preferentially.

The electron-donating compounds may be chosen from the known Lewis bases, such as pyridines, amines, amides, esters, sulfoxides and the like. Among these, DMSO (dimethyl sulfoxide) and DMAc (dimethylacetamide) are preferred.

The living cationic polymerization is performed in an apolar inert solvent or in a mixture of apolar and polar inert solvents.

The apolar solvents that may be used for the synthesis of the copolymers according to the invention are, for example, aliphatic, cycloaliphatic or aromatic hydrocarbon-based solvents, such as hexane, heptane, cyclohexane, methylcyclohexane, benzene or toluene.

The polar solvents that may be used for the synthesis of the copolymers according to the invention are, for example, halogenated solvents such as alkyl halides, for instance methyl chloride (or chloroform), ethyl chloride, butyl chloride, methylene chloride (or dichloromethane) or chlorobenzenes (mono-, di- or trichloro).

A person skilled in the art will know how to select the composition of the mixtures of monomers to be used in order to prepare the block thermoplastic elastomeric copolymers according to the invention, and also the appropriate temperature conditions in order to achieve the molar mass characteristics of these copolymers.

As illustrative but nonlimiting examples, and in order to perform this first synthetic strategy, a person skilled in the art may refer to the following documents for the synthesis of block copolymers based on isobutylene and:
acenaphthylene: the article by Z. Fodor and J. P. Kennedy, Polymer Bulletin 1992 29(6) 697-705;
indene: U.S. Pat. No. 4,946,899 by the Inventors Kennedy, Puskas, Kaszas and Hager and documents J. E. Puskas, G. Kaszas, J. P. Kennedy, W. G. Hager Journal of Polymer Science Part A: Polymer Chemistry (1992) 30, 41 and J. P. Kennedy, N. Meguriya, B. Keszler, Macromolecules (1991) 24(25), 6572-6577;
isoprene: documents G. Kaszas, J. E. Puskas, P. Kennedy Applied Polymer Science (1990) 39(1) 119-144 and J. E. Puskas, G. Kaszas, J. P. Kennedy, Macromolecular Science, Chemistry A28 (1991) 65-80.

A second synthetic strategy consists in separately preparing:
a “polyisobutylene” block that is telechelic or functional at one or more of its chain ends by living cationic polymerization using a monofunctional, difunctional or polyfunctional initiator, optionally followed by a functionalization reaction on one or more chain ends,
thermoplastic block(s) with a Tg of greater than or equal to 100° C., which are living, for example by anionic polymerization,
and then in reacting each of them to obtain a block copolymer according to the invention. The nature of the reactive functions at least one of the chain ends of the “polyisobutylene” block and the proportion of living chains in the polymer constituting the thermoplastic block with a Tg of greater than or equal to 100° C., relative to the amount of these reactive functions, will be chosen by a person skilled in the art to obtain a block copolymer according to the invention.

A third synthetic strategy consists in performing, in this order:
the synthesis of a “polyisobutylene” block that is telechelic or functional at one or more of its chain ends by living cationic polymerization using a monofunctional, difunctional or polyfunctional initiator;
the modification at the end of the chain of this “polyisobutylene” so as to introduce a monomer unit that can be lithiated;
optionally, the further addition of a monomer unit that can be lithiated and that can lead to a species capable of initiating an anionic polymerization, for instance 1,1-diphenylethylene;
finally, the addition of the polymerizable monomer and of optional comonomers anionically.

By way of example, for the use of such a synthetic strategy, a person skilled in the art may refer to the communication from Kennedy and Price, ACS Symposium, 1992, 496, 258-277 or to the article by Faust et al.: Facile synthesis of diphenylethylene endfunctional polyisobutylene and its applications for the synthesis of block copolymers containing poly(methacrylate)s, by Dingsong Feng, Tomoya Higashihara and Rudolf Faust, Polymer, 2007, 49(2), 386-393.

The halogenation of the copolymer according to the invention is performed according to any method known to those skilled in the art, especially those used for the halogenation of butyl rubber, and may take place, for example, using bromine or chlorine, preferentially bromine, on the conjugated diene-based units of the polymer chain of the “polyisobutylene” block and/or of the thermoplastic block(s).

In certain variants of the invention according to which the thermoplastic elastomer is a star or branched elastomer, the processes described, for example, in the articles by Puskas J. Polym. Sci Part A: Polymer Chemistry, vol. 36, pp 85-82 (1998) and Puskas, J. Polym. Sci Part A: Polymer Chemistry, vol. 43, pp 1811-1826 (2005) may be performed by analogy to obtain star, branched or living dendrimer “polyisobutylene” blocks. A person skilled in the art will then know how to select the composition of the mixtures of monomers to be used in order to prepare the copolymers according to the invention and also the appropriate temperature conditions in order to achieve the molar mass characteristics of these copolymers.

Preferentially, the preparation of the copolymers according to the invention will be performed by living cationic polymerization using a difunctional or polyfunctional initiator and by sequential additions of the monomers to be polymerized for the synthesis of the “polyisobutylene” block and of the monomers to be polymerized for the synthesis of the thermoplastic block(s) with a Tg of greater than or equal to 100° C.

The block elastomer according to the invention may by itself constitute the elastomeric composition or may be combined, in this composition, with other constituents to form an elastomeric matrix.

If other optional elastomers are used in this composition, the block thermoplastic elastomeric copolymer according to the invention constitutes the elastomer that is in weight majority, i.e. the weight fraction of the block copolymer relative to all of the elastomers is the highest. The block copolymer preferably represents more than 50% and more preferentially more than 70% by weight of all of the elastomers. Such additional elastomers may, for example, be diene elastomers or thermoplastic styrene (TPS) elastomers, in the limit of the compatibility of their microstructures.

As diene elastomers that may be used in addition to the block thermoplastic elastomer described previously, mention may be made especially of polybutadienes (BR), synthetic polyisoprenes (IR), natural rubber (NR), butadiene copolymers, isoprene copolymers and mixtures of these elastomers. Such copolymers are more preferentially chosen from the group formed by butadiene-styrene copolymers (SBR), isoprene-butadiene copolymers (BIR), isoprene-styrene copolymers (SIR), isoprene-isobutylene copolymers (IIR) and isoprene-butadiene-styrene copolymers (SBIR), and mixtures of such copolymers.

As TPS elastomers that may be used in addition to the block thermoplastic elastomer described previously, mention may be made especially of a TPS elastomer chosen from the group formed by styrene/butadiene/styrene block copolymers, styrene/isoprene/styrene and styrene/butylene/styrene block copolymers, styrene/isoprene/butadiene/styrene block copolymers, styrene/ethylene/butylene/styrene block copolymers, styrene/ethylene/propylene/styrene block copolymers, styrene/ethylene/ethylene/propylene/styrene block copolymers, and mixtures of these copolymers. More preferentially, said optional additional TPS elastomer is chosen from the group formed by styrene/ethylene/butylene/styrene block copolymers, styrene/ethylene/propylene/styrene block copolymers and mixtures of these copolymers.

The block copolymer described previously is sufficient by itself to satisfy the gastight function with respect to the inflatable objects in which it may be used.

However, according to one preferential embodiment of the invention, said copolymer is used in a composition that also comprises, as plasticizer, an extender oil (or plasticizing oil) whose function is to facilitate the implementation, particularly the incorporation into the inflatable object by lowering the modulus and increasing the tack power of the gastight layer.

Any extender oil, preferably of weakly polar nature, which is capable of extending or plasticizing elastomers, especially thermoplastic elastomers, may be used. At room temperature (23° C.), these more or less viscous oils are liquid (i.e. as a reminder, substances having the capacity of taking over time the shape of their container), as opposed especially to resins or rubbers, which are solid by nature.

Preferably, the extender oil is chosen from the group formed by polyolefinic oils (i.e. oils derived from the polymerization of olefins, monoolefins or diolefins), paraffinic oils, naphthenic oils (of low or high viscosity), aromatic oils and mineral oils, and mixtures of these oils.

It should be noted that the addition of an extender oil to the SIBS leads to a loss of sealing of the latter, which is variable depending on the type and amount of oil used. An oil of the polybutene type is preferentially used, in particular a polyisobutylene oil (abbreviated as “PIB”), which has demonstrated the best compromise of properties compared with the other oils tested, especially a conventional oil of the paraffinic type.

By way of example, polyisobutylene oils are sold especially by the company Univar under the name Dynapak Poly (e.g. Dynapak Poly 190), by Ineos Oligomer under the name Indopol H1200, by BASF under the name Glissopal (e.g. Glissopal 1000) or Oppanol (e.g. Oppanol B12); paraffinic oils are sold, for example, by Exxon under the name Telura 618 or by Repsol under the name Extensol 51.

The number-average molecular mass (Mn) of the extender oil is preferentially between 200 and 25 000 g/mol and even more preferentially between 300 and 10 000 g/mol. For excessively low Mn masses, there is a risk of migration of the oil out of the composition, whereas excessively high masses may lead to excessive rigidification of this composition. An Mn of between 350 and 4000 g/mol, in particular between 400 and 3000 g/mol, has proven to be an excellent compromise for the intended applications, in particular for use in a pneumatic tyre.

A person skilled in the art will know how to adjust the amount of extender oil as a function of the particular working conditions of the composition.

It is preferred for the content of extender oil to be greater than 5 phr and preferably between 5 and 100 phr (parts by weight per hundred parts of total elastomer, i.e. the thermoplastic elastomer plus any other possible elastomer present in the composition or elastomeric layer).

Below the indicated minimum, the elastomeric composition runs the risk of being too rigid for certain applications, whereas beyond the recommended maximum, there is a risk of insufficient cohesion of the composition and of loss of sealing that may be detrimental depending on the application under consideration.

For these reasons, in particular for use of the airtight composition in a pneumatic tyre, it is preferred for the content of extender oil to be greater than 10 phr, especially between 10 and 90 phr, more preferentially greater than 20 phr and especially between 20 and 80 phr.

The composition described above may moreover comprise the various additives usually present in the airtight layers known to those skilled in the art. Mention will be made, for example, of reinforcing fillers such as carbon black or silica, nonreinforcing or inert fillers, colourants that may advantageously be used for colouring the composition, platy fillers for further improving the impermeability (e.g. phyllosilicates, such as kaolin, talc, mica, graphite, clays or modified clays (“organo clays”), plasticizers other than the abovementioned extender oils, protective agents such as antioxidants or antiozonants, UV stabilizers, various processing aids or other stabilizers, a crosslinking system, for example based either on sulphur and/or peroxide and/or bismaleimides or any other means for crosslinking chains, or alternatively promoters suitable for promoting the adhesion to the rest of the structure of the inflatable object.

The block elastomer according to the invention has the advantage, on account of its thermoplastic nature, of being able to be worked in its existing state in melt form (liquid), and consequently of offering a possibility of simplified implementation of the elastomeric composition containing it.

Moreover, despite its thermoplastic nature, the block elastomer gives the composition containing it good cohesion of the material when hot, especially at temperatures ranging from 100° C. to 200° C.

In addition, the composition according to the invention comprising the block thermoplastic elastomer has improved hysteretic properties when compared with a composition based on butyl rubber.

Another subject of the invention is, accordingly, an inflatable object equipped with an elastomeric layer that is impermeable to inflation gases such as air, said elastomeric layer being formed from the elastomeric composition comprising at least, as majority elastomer, one block thermoplastic elastomer described above.

Besides the elastomers (thermoplastic and other optional elastomers) described previously, the gastight composition may also comprise, still in a minor weight fraction relative to the block thermoplastic elastomer, polymers other than elastomers, for instance thermoplastic polymers that are compatible with the block thermoplastic elastomer.

The gastight layer or composition described previously is a solid (at 23° C.) elastic compound, which is especially characterized, by virtue of its specific formulation, by very high flexibility and very high deformability.

The layer or composition based on a block thermoplastic elastomer described previously may be used as an airtight layer in any type of inflatable object. Examples of such inflatable objects that may be mentioned include inflatable boats, and balls used for play or sport.

It is particularly suitable for use as an airtight layer (or layer that is impermeable to any other inflation gas, for example nitrogen) in an inflatable object, finished or semifinished product, made of rubber, most particularly in a pneumatic tyre for a motor vehicle such as a two-wheeled, passenger or industrial vehicle.

Such an airtight layer is preferentially placed on the inner wall of the inflatable object, but it may also be fully integrated into its internal structure.

The thickness of the airtight layer is preferentially greater than 0.05 mm and more preferentially between 0.1 mm and 10 mm (especially between 0.1 and 1.0 mm).

It will be readily understood that, depending on the specific fields of application, and the dimensions and pressures that come into play, the mode of implementation of the invention may vary, the airtight layer then comprising several preferential ranges of thickness.

When compared with a usual airtight layer based on butyl rubber, the airtight composition described above has the advantage of having markedly lower hysteresis and is thus a sign of offering reduced rolling resistance for pneumatic tyres.

In addition, this block thermoplastic elastomer with a Tg of greater than or equal to 100° C., despite its thermoplastic nature, affords the airtight composition containing it good hot cohesion of the material, especially at temperatures ranging from 100° C. to 200° C. These temperatures correspond to the annealing temperatures of pneumatic tyres. This high-temperature cohesion allows hot stripping of these tyres from the moulds without impairing the integrity of the airtight composition containing said block thermoplastic elastomer. This high-temperature cohesion also allows use of the tyres under extreme conditions that may induce significant temperature increases within the inner liner.

The gastight elastomer layer described previously may advantageously be used in pneumatic tyres for all types of vehicles, in particular passenger vehicles or industrial vehicles such as heavy vehicles.

By way of example, the attached single FIGURE shows very schematically (without being drawn to a specific scale) a radial cross section of a pneumatic tyre in accordance with the invention.

This pneumatic tyre 1 comprises a crown 2 reinforced with a crown reinforcement or belt 6, two sidewalls 3 and two beads 4, each of these beads 4 being reinforced with a bead wire 5. Mounted on the crown 2 is a tread, which is not shown in this schematic FIGURE. A carcass reinforcement 7 is wound around the two bead wires 5 in each bead 4, the upturn 8 of this reinforcement 7 being arranged, for example, towards the exterior of the tyre 1, which is shown here mounted on its rim 9. The carcass reinforcement 7 is, in a known manner, formed from at least one ply reinforced with “radial” cords, for example textile or metallic cords, i.e. these cords are arranged practically parallel to each other and extend from one bead to another so as to form an angle of between 80° and 90° with the median circumferential plane (plane perpendicular to the axis of rotation of the tyre which is located halfway between the two beads 4 and passes through the middle of the crown reinforcement 6).

The inner wall of the pneumatic tyre 1 comprises an airtight layer 10, for example with a thickness of about 0.9 mm, on the inner cavity 11 side of the pneumatic tyre 1.

This inner layer (or “inner liner”) covers the entire inner wall of the pneumatic tyre, extending from one sidewall to the other, at least up to the rim flange when the pneumatic tyre is in the mounted position. It defines the radially inner face of said tyre intended to protect the carcass reinforcement from diffusion of air coming from the inner space 11 of the tyre. It allows the pneumatic tyre to be inflated and maintained under pressure; its sealing properties must allow it to ensure a relatively low rate of pressure loss, to keep the tyre inflated, in the state of normal functioning, for a sufficient duration, normally for several weeks or several months.

In contrast with a conventional pneumatic tyre using a composition based on butyl rubber, the pneumatic tyre in accordance with the invention uses in this example, as airtight layer 10, a composition based on a block thermoplastic elastomer as described above in which the thermoplastic block(s) have a Tg of greater than or equal to 100° C.

The tyre equipped with its airtight layer 10 as described above may be made before or after vulcanization (or curing).

In the first case (i.e. before curing the pneumatic tyre), the airtight layer is simply applied conventionally to the desired place, for formation of the layer 10. Vulcanization is then performed conventionally. The block thermoplastic elastomers according to the invention satisfactorily withstand the stresses associated with the vulcanization step.

One manufacturing variant that is advantageous for a person skilled in the art of pneumatic tyres will consist, for example during a first step, in laying down the airtight layer directly onto a building drum, in the form of a skim of suitable thickness, before this is covered with the rest of the structure of the pneumatic tyre, according to manufacturing techniques that are well known to those skilled in the art.

In the second case (i.e. after curing the pneumatic tyre), the airtight layer is applied to the interior of the cured pneumatic tyre by any suitable means, for example by bonding, by spraying or extrusion and blow-moulding of a film of suitable thickness.

1. Elastomeric composition, wherein said composition comprises at least, as majority elastomer, one block thermoplastic elastomer comprising
1) a “polyisobutylene” block with a number-average molecular mass ranging from 25 000 g/mol to 350 000 g/mol and a glass transition temperature of less than or equal to −20° C.,
2) at least one of the ends of the “polyisobutylene” block, a thermoplastic block made from at least one polymerized monomer other than a styrene or indene monomer, whose glass transition temperature is greater than or equal to 100° C.

2. Elastomeric composition according to claim 1, wherein the copolymer has a linear triblock structure.

3. Elastomeric composition according to claim 1, wherein the copolymer has a star structure with at least three arms and not more than 12 arms, in which the “polyisobutylene” block is a star block with at least 3 and not more than 12 arms, each ending with a thermoplastic block.

4. Elastomeric composition according to claim 1, wherein the copolymer has a dendrimer structure in which the “polyisobutylene” block is a dendrimer, each of the arms of the dendrimer “polyisobutylene” ending with a thermoplastic block.

5. Elastomeric composition according to claim 1, wherein the “polyisobutylene” block comprises a content of units derived from one or more conjugated dienes inserted into the polymer chain ranging from 0.5% to 16% by weight relative to the weight of the “polyisobutylene” block.

6. Elastomeric composition according to claim 5, wherein the “polyisobutylene” block is halogenated.

7. Elastomeric composition according to claim 1, wherein the polymerized monomer other than a styrene or indene monomer constituting the thermoplastic block is chosen from acenaphthylene, isoprene, acrylic acid, crotonic acid, sorbic acid or methacrylic acid esters, acrylamide derivatives, methacrylamide derivatives, acrylonitrile derivatives and methacrylonitrile derivatives.

8. Elastomeric composition according to claim 1, wherein the monomer other than a styrene or indene monomer constituting the thermoplastic block is copolymerized with a comonomer chosen from conjugated diene monomers containing 4 to 12 carbon atoms, monomers of vinylaromatic type containing from 8 to 20 carbon atoms and indene monomers.

9. Elastomeric composition according to claim 8, wherein the comonomer is styrene.

10. Elastomeric composition according to claim 1, further comprising an extender oil for the elastomer.

11. Elastomeric composition according to claim 10, wherein the content of extender oil is from 5 phr to 100 phr.

12. Composition according to claim 1, further comprising a platy filler.

13. Inflatable object equipped with an elastomeric layer that is impermeable to inflation gases, wherein said elastomeric layer is formed from an elastomeric composition as defined in claim 1.

14. Inflatable object according to claim 13, in which the airtight layer has a thickness of between 0.05 mm and 10 mm.

15. Inflatable object according to claim 14, in which the airtight layer is placed on the inner wall of the inflatable object.

16. Inflatable object according to claim 13, wherein said object is a pneumatic tire.

17. Inflatable object according to claim 13, wherein said inflatable object is an inner tube.

18. Inflatable object according to claim 17, wherein said inner tube is a pneumatic tire inner tube.

19. Process for sealing an inflatable object with respect to inflation gases, in which a gastight elastomeric layer formed from a composition as defined in claim 1 is incorporated into said inflatable object during its manufacture, or is added to said inflatable object after its manufacture.

20. Process according to claim 19, wherein the airtight elastomeric layer is placed on the inner wall of the inflatable object.

21. Process according to claim 20, wherein the object is a pneumatic tire.

22. Process according to claim 21, wherein, during a first step, the airtight elastomeric layer is laid down directly onto a building drum, before said layer is covered with the rest of the structure of the pneumatic tire.

23. A method of making an inflatable object impermeable to inflation gases, comprising introducing into the inflatable object a layer of an elastomeric composition as defined in any claim 1.
